(19) United States
(12) Patent Application Publication
(10) Pub. No.: US 2013/0298445 A1
(43) Pub. Date: Nov. 14, 2013

(54) INSECT PEST DISINFESTATION LIGHTING SYSTEM

(71) Applicant: PANASONIC CORPORATION, Osaka (JP)

(72) Inventors: Shinichi AOKI, Osaka (JP); Makoto YAMADA, Osaka (JP); Masaki ISHIWATA, Osaka (JP)

(73) Assignee: PANASONIC CORPORATION, Osaka (JP)

(21) Appl. No.: 13/836,293

(22) Filed: Mar. 15, 2013

(30) Foreign Application Priority Data
May 11, 2012 (JP) 2012-110052

(51) Int. Cl. A01M 1/04; A01M 1/20

(52) U.S. Cl. CPC A01M 1/04; A01M 1/20
USPC 43/132.1

(57) ABSTRACT

An insect pest disinfestation lighting system including a light source that illuminates a rear side of a leaf of a plant with light having a wavelength from 260 to 305 nm in a range of 2 to 50 μW/cm².

### CROSS-REFERENCE TO RELATED APPLICATIONS

This application is based upon and claims the benefit of priority from prior Japanese Patent Application No. 2012-110052, filed on May 11, 2012, the entire contents of which are incorporated herein by reference.

### FIELD

The present invention relates to an insect pest disinfestation lighting system.

### BACKGROUND

Insect pests, such as spider mites, feed on plants and are thus troublesome. Japanese Laid-Open Patent Publication No. 2011-72200 describes the use of light to attract phytoseiidae, which are predators of spider mites, to disinfest spider mites.

### SUMMARY

The insect pest disinfestation process described above involves the attraction of phytoseiidae. It is thus desirable that a lighting device be developed to disinfest spider mites without attracting phytoseiidae.

One aspect of the present invention is an insect pest disinfestation lighting system including a light source that illuminates a rear side of a leaf of a plant with light having a wavelength from 260 to 305 nm in a range of 2 to 50 μW/cm² .

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating a first embodiment of an insect pest disinfestation lighting system including an insect pest disinfestation lighting device;

FIG. 2 is a graph schematically illustrating the spectral properties of a light source;

FIG. 3 is a table illustrating test results for conditions A to K and comparative examples 1 to 3;

FIG. 4 is a schematic diagram illustrating a second embodiment of an insect pest disinfestation lighting system including an insect pest disinfestation lighting device;

FIGS. 5 to 13, 14A, 14B, 15, 16, 17A, and 17B are schematic diagrams illustrating examples of other insect pest disinfestation lighting systems including insect pest disinfestation lighting devices;

FIG. 18 is a schematic block diagram illustrating the electrical configuration of a further example of an insect pest disinfestation lighting system; and

FIG. 19 is a schematic diagram illustrating another example of an insect pest disinfestation lighting system.

### DESCRIPTION OF THE EMBODIMENTS

A first embodiment of an insect pest disinfestation lighting system will now be described.

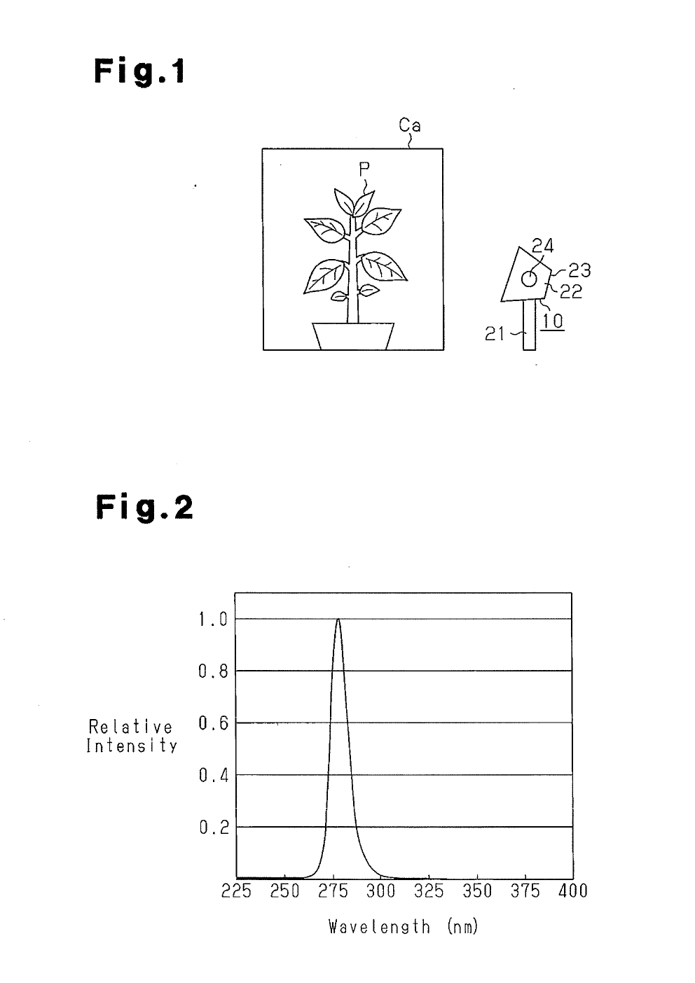

Referring to FIG. 1, an insect pest disinfestation lighting system includes an insect pest disinfestation lighting device 10.

The insect pest disinfestation lighting device 10 includes a lighting body 22, which is coupled to a distal end of a cylindrical pole 21. The lighting body 22 includes a light source 24, which is arranged in a box-shaped housing 23.

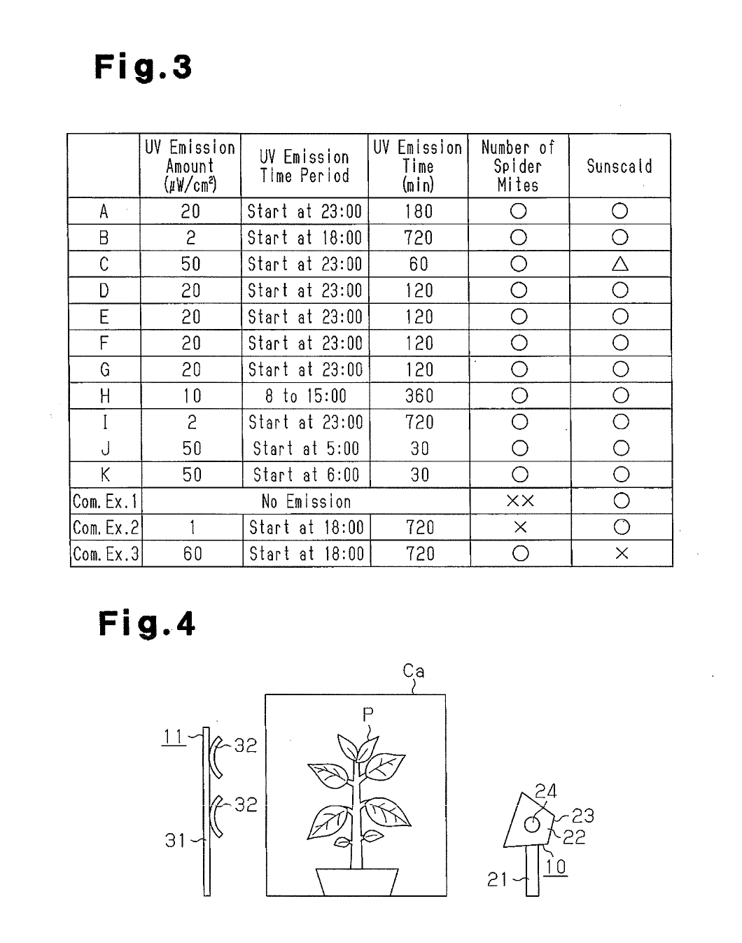

The light source 24 outputs light with a wavelength from 260 to 305 nm (UV light). In the first embodiment, referring to FIG. 2, the light source 24 outputs light having a peak wavelength of 280 nm.

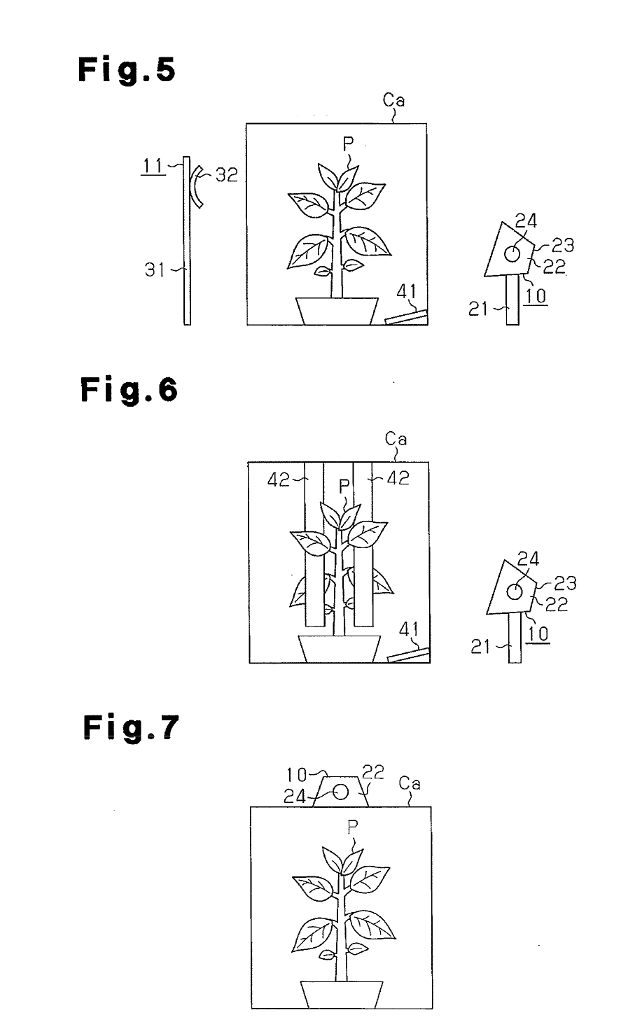

The insect pest disinfestation lighting device 10 activates the light source 24 when supplied with power from a power supply (not illustrated) to illuminate a plant P with light. Referring to FIG. 3, the light source 24 emits light under, for example, illumination condition A in which light is emitted at a UV emission amount of 20 μW/cm² for 180 minutes starting at 23:00.

The inventors of the present invention conducted a test to check the effects when emitting light from the light source 24 under condition A. The plant (e.g., cucumber) was placed in a transparent container Ca, the dimensions of which was approximately 1 m×1 m×1.5 m, and cultivated in the usual manner. Five spider mites were arranged on lower leaves of the plant P five to seven days after starting the cultivation of the plant P. The insect pest disinfestation lighting device 10 was activated three days after the arrangement of the spider mites. The test was conducted under the same conditions on three plants P in three transparent containers Ca to check the effects using the average observation value of the three plants P. The effects were checked based on two items, namely, the number of spider mites and sunscald. The results are illustrated in FIG. 3. The number of spider mites was visually counted using a magnifying lens. In the table, with regard to spider mites, two crosses indicate that the presence of spider mites was easily recognized, a single cross indicates that the presence of spider mites was recognized relatively easily, and a circle indicates that the presence of spider mites was hardly recognized. With regard to sunscald, a cross indicates that sunscald was recognized at multiple locations, a triangle indicates that sunscald was recognized on one or two leaves of a single plant P, and a circle indicates that sunscald was hardly recognized.

For comparison with condition A, the inventors of the present invention conducted a similar test on comparative example 1, which is illustrated in FIG. 3. The test comparative example 1 was conducted under the conditions in which the light source 24 was not activated, that is, UV light was not emitted.

### Comparison of Condition A and Comparative Example 1

As illustrated in FIG. 3, in comparative example 1, the presence of spider mites was easily recognized. In contrast, under condition A, the presence of spider mites was hardly recognized. Accordingly, spider mites were disinfested when the light source 24 illuminated the rear sides of leaves with light.

The insect pest disinfestation lighting system of the first embodiment has the advantages described below.

(1) The light source 24 illuminates the rear sides of the leaves of the plant P with light in the wavelength of 260 to 305 nm with a UV emission amount of 20 μW/cm², which is in the range of 2 to 50 μW/cm². The use of the light source 24 thus disinfests spider mites.

(2) The light source 24 emits light in an emission direction set in a range from the horizontal direction to the vertically upward direction to illuminate the rear sides of the leaves of the plant P. The rear sides of the leaves of the plant P are usually faced downward relative to the vertical direction. Thus, the emission of light in the above range illuminates the rear sides of the leaves with light and disinfests spider mites.

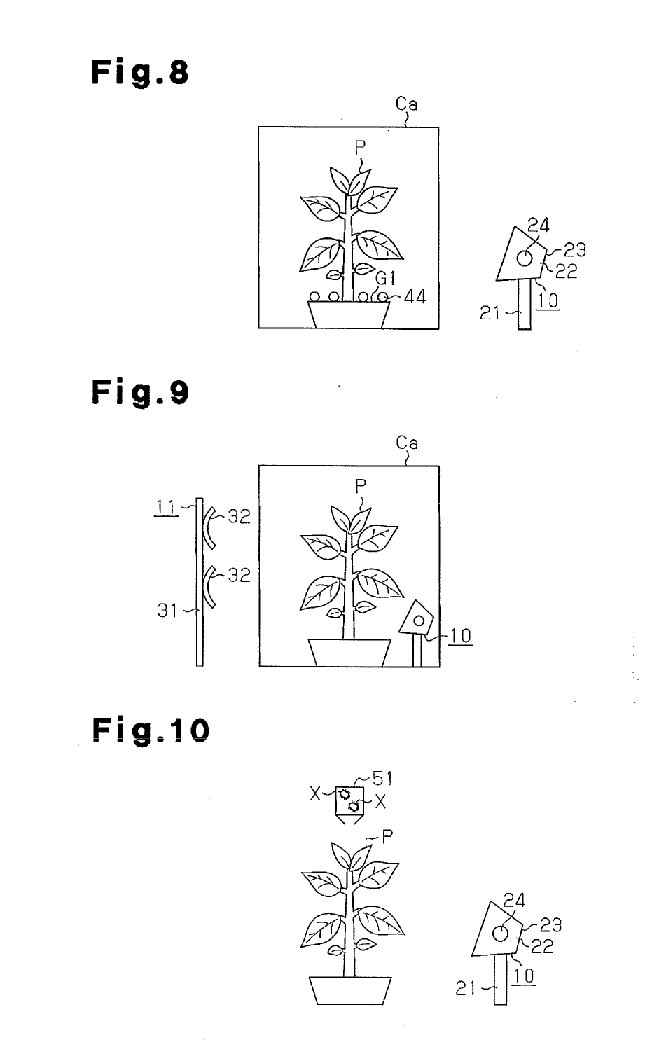

A second embodiment of an insect pest disinfestation lighting system will now be described with reference to FIG. 4. Like or same reference numerals are given to those components that are the same as the corresponding components of the first embodiment.

As illustrated in FIG. 4, the insect pest disinfestation lighting system of the second embodiment includes a light reflector 11. The insect pest disinfestation lighting device 10 and the light reflector 11 are arranged at opposite sides of the plant P.

The light reflector 11 includes a plurality of (two illustrated in FIG. 1) reflection plates 32 arranged on a cylindrical support 31. The reflection plates 32 reflect light. Miro (registered trademark), which is manufactured by Alanod, may be used as a reflective material that reflects UV light.

The insect pest disinfestation lighting device 10 activates the light source 24 when supplied with power from a power supply (not illustrated) to illuminate the plant P with light. The light source 24 emits light under one of the conditions B to D illustrated in FIG. 3. For example, under condition B, the light source 24 emitted light with a UV emission amount of 2 μW/cm² for 720 minutes starting at 18:00. Under condition C, the light source 24 emitted light with a UV emission amount of 50 μW/cm² for 60 minutes starting at 23:00. Under condition D, the light source 24 emitted light with a UV emission amount of 20 μW/cm² for 120 minutes starting at 23:00. In the same manner as the first embodiment, tests were conducted under the conditions B to D.

For comparison with condition B, the inventors of the present invention conducted a similar test on comparative example 2, which is illustrated in FIG. 3. The test on comparative example 2 was conducted under the conditions in which the light source 24 emitted light with a UV emission amount of 1 μW/cm² for 720 minutes starting at 18:00.

Further, for comparison with condition B, a similar test was conducted on comparative example 3. The test on comparative example 3 was conducted under the conditions in which the light source 24 emitted light with a UV emission amount of 60 μW/cm² for 720 minutes starting at 18:00.

### Comparison of Condition B and Comparative Example 2

As illustrated in FIG. 3, in comparative example 2, the presence of spider mites was recognized relatively easily. In contrast, under condition B, the presence of spider mites was hardly recognized. Accordingly, spider mites were disinfested when the light source 24 illuminated the rear sides of leaves with light at a UV emission amount of 2 μW/cm².

### Comparison of Conditions B to D and Comparative Example 2

As illustrated in FIG. 3, in comparative example 3, sunscald was recognized on multiple leaves of a single plant P. In contrast, under condition B, sunscald was hardly recognized. From the test results, it may be understood that sunscald occurs when the UV emission amount is simply increased. When adjusting the UV emission amount of the light source to 50 μW/cm² like under condition C, sunscald was recognized on one to two leaves of a single plant P. From the test result, it may be understood that by adjusting the UV emission amount of the light source to 50 μW/cm², sunscald may be relatively decreased while disinfesting spider mites. Further, when adjusting the UV emission amount of the light source to 20 μW/cm² like under condition D, sunscald was hardly recognized. From the test result, it may be understood that by adjusting the UV emission amount of the light source to 20 μW/cm², sunscald may be further decreased while disinfesting spider mites.

The second embodiment of the insect pest disinfestation lighting system has the advantages described below in addition to advantages (1) and (2).

(3) The reflection plates 32 function as reflectors that reflect the light of the light source 24. Accordingly, in addition to the light of the light source 24, the plant P is illuminated with light reflected by the reflection plates 32. This structure illuminates the leaves of the plant P with light from the light source 24 over a wide area. Thus, spider mites are effectively disinfested.

It should be apparent to those skilled in the art that the present invention may be embodied in many other specific forms without departing from the spirit or scope of the invention. Particularly, it should be understood that the present invention may be embodied in the following forms.

The second embodiment includes more than one (e.g., two) reflection plates 32. However, there may be only one reflection plate 32.

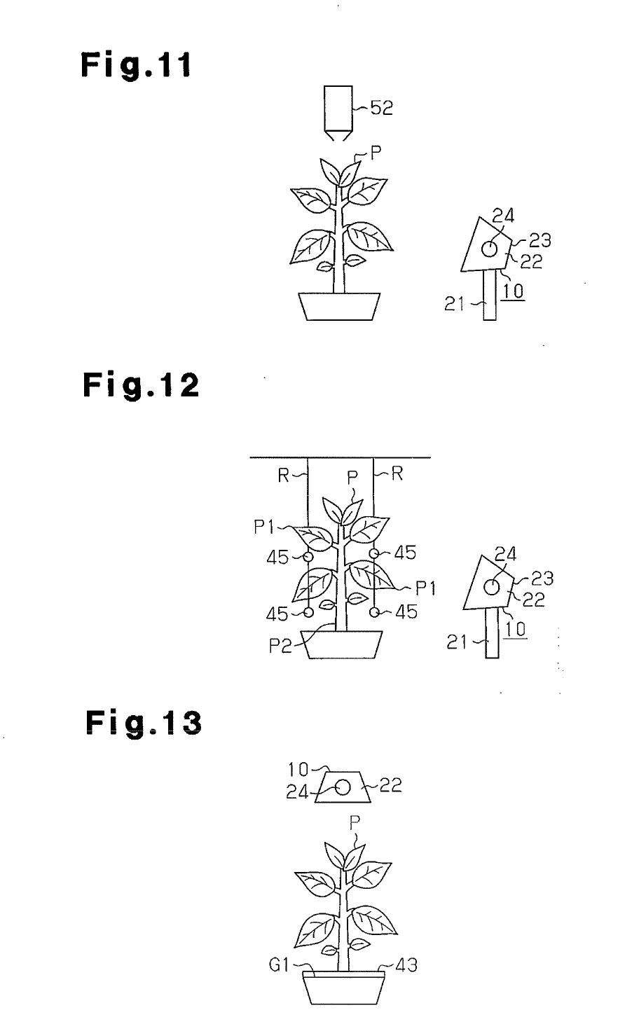

Although not particularly mentioned, in the second embodiment, for example, as illustrated in FIG. 5, a reflection plate 41 (reflector) may be arranged below the plant P. In addition to the reflection plate 41, the lighting system illustrated in FIG. 5 includes a single reflection plate 32. The reflection plate 32 and the insect pest disinfestation lighting device 10 (light source 24) are arranged at opposite sides of the plant P. In the same manner as the above embodiments, a test was conducted on the lighting system of FIG. 5. Under condition E illustrated in FIG. 3, the light source 24 emitted light with a UV emission amount of 20 μW/cm² for 120 minutes starting at 23:00. Under such a condition, the lighting system disinfested spider mites while decreasing sunscald.

The second embodiment uses curved reflection plates 32 as the reflectors. However, instead of the reflection plates 32, for example, as illustrated in FIG. 6, strips of reflection sheets 42 (reflectors) may be used. In the same manner as the above embodiments, a test was conducted on the lighting system of FIG. 6. Under condition F illustrated in FIG. 3, the light source 24 emitted light with a UV emission amount of 20 μW/cm² for 120 minutes starting at 23:00. Under such a condition, the lighting system disinfested spider mites while decreasing sunscald.

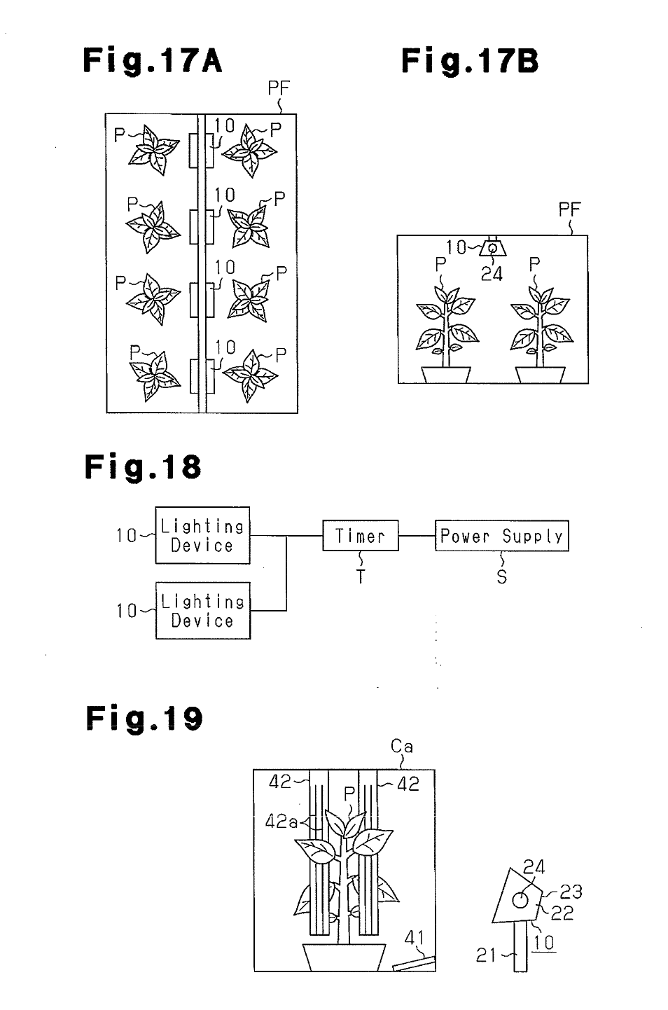

As illustrated in the example of FIG. 19, the reflection sheets 42 may include slits 42a that allow the passage of light. In such a structure, in addition to reflecting light from the light source 24, the reflection sheets 42 may pass sunlight or the like through the slits 42a. This prevents the reflection sheets 42 from impeding the growth of the plant P. Through holes may be formed in lieu of the slits 42a.

In the second embodiment, in the same manner as the first embodiment, the light source 24 emits light in a range set from the horizontal direction to the vertically upward direction. However, the emission direction is not limited to this range. For example, as illustrated in FIG. 7, a light source 24 (lighting body 22) may be arranged above the plant P to emit light in the vertically downward direction toward the plant P. In this manner, when arranging the light source 24 above the plant P, it is desirable that a reflector 43 be arranged under the plant P (e.g., culture medium G1 of the plant P) as illustrated in FIG. 13 to reflect light in the vertically upward direction. This structure allows for the rear sides of the leaves of the plant P to be illuminated with light even when the emission direction of the light from the light source 24 is set in the range from the horizontal direction to the vertically downward direction.

In the same manner as the above embodiments, a test was conducted on the lighting system of FIG. 7. Under condition G illustrated in FIG. 3, the light source 24 emitted light with a UV emission amount of 20 μW/cm² for 120 minutes starting at 23:00. Under such a condition, the lighting system disinfested spider mites while decreasing sunscald.

When arranging the reflector 43 under the plant P (e.g., culture medium G1 of the plant P), it is desirable that the reflector 43 include through holes 43a as illustrated in FIGS. 14A and 14B. The through holes 43a allow for the passage of water when watering the culture medium G1.

The second embodiment uses the reflection plates 32 as reflectors. Instead, as illustrated in the example of FIG. 8, reflection grains 44 (reflector) may be arranged on the culture medium G1 of the plant P. For example, the reflection grains 44 may be formed from barium sulfate (BaSO₄). This allows for the reflector to be mixed with the soil of the culture medium G1 and prevents the reflector from impeding temperature rises in the soil of the culture medium G1 when illuminated with sunlight. Further, the reflection grains 44 do not obstruct the job of a worker cultivating the plant P.

In the same manner as the above embodiments, a test was conducted on the lighting system of FIG. 8. Under condition H illustrated in FIG. 3, the light source 24 emitted light with a UV emission amount of 10 μW/cm² for 360 minutes from 08:00 to 15:00. Under such a condition, the lighting system disinfested spider mites while decreasing sunscald.

In the second embodiment, the insect pest disinfestation lighting device 10 (light source 24) is arranged outside the transparent container Ca. Instead, as illustrated in FIG. 9, the insect pest disinfestation lighting device 10 (light source 24) may be arranged inside the transparent container Ca.

In the same manner as the above embodiments, a test was conducted on the lighting system of FIG. 9. Under condition I illustrated in FIG. 3, the light source 24 emitted light with a UV emission amount of 2 μW/cm² for 720 minutes starting at 23:00. Under such a condition, the lighting system disinfested spider mites while decreasing sunscald.

Although not particularly mentioned in the above embodiments, as illustrated in FIG. 10, the insect pest disinfestation lighting system may include a predator releaser 51 that releases a predator X (e.g., amblyseius womersleyi and scolothrips takahashii) of the insect pest (spider mite), which is subject to disinfestation by the light from the light source 24. The predator X disinfests spider mites.

In the same manner as the above embodiments, a test was conducted on the lighting system of FIG. 10. Under condition J illustrated in FIG. 3, the light source 24 emitted light with a UV emission amount of 50 μW/cm² for 30 minutes starting at 05:00. Under such a condition, the lighting system disinfested spider mites while decreasing sunscald. Further, the predator X also disinfests spider mites.

Although not particularly mentioned in the above embodiments, as illustrated in FIG. 11, the insect pest disinfestation lighting system may include a pesticide sprayer 52 that sprays pesticide (e.g., Affirm insecticide) on the plant P. This structure allows for pesticide to be sprayed to locations that cannot be reached by light and disinfests spider mites in a further preferable manner.

In the same manner as the above embodiments, a test was conducted on the lighting system of FIG. 11. Under condition K illustrated in FIG. 3, the light source 24 emitted light with a UV emission amount of 50 μW/cm² for 30 minutes starting at 06:00. It is desirable that the pesticide sprayer 52 spray pesticide at the boundaries between the stem and the leaves of the plant P. Under such a condition, the lighting system disinfested spider mites while decreasing sunscald. Moreover, the pesticide disinfested spider mites in a further preferable manner.

In the second embodiment, the light source 24 and the reflection plates 32 (reflectors) are arranged at opposite sides of the plant P. Instead, as illustrated in the example of FIG. 12, spherical reflectors 45 may be arranged between distal portions P1 of the leaves of the plant P and the stem P2 of the plant P. Preferably, the reflectors 45 are supported by strings R or the like to be movable (swayable) when an air current flows. This structure allows for the reflectors 45 to sway so that the light from the light source 24 is travels in random directions. Accordingly, in comparison to when the reflectors 45 are fixed in a non-movable manner, light may be emitted over a wider range. The reflectors 45 illustrated in FIG. 12 are formed by applying reflection material of flash-spun non-woven fabrics (e.g., Tyvek, registered trademark) to spheres of foamed styrol.

Although not particularly mentioned in the above embodiments, the insect pest disinfestation lighting system may include a moving unit that upwardly moves the distal portions P1 of the leaves of the plant P. As illustrated in FIG. 15, a fan 60 may be used as the moving unit to produce an air current that upwardly moves the distal portions P1 of the leaves. As illustrated in FIG. 16, strings R1 arranged at the lower sides (rear sides) of the leaves may be used as another moving unit. In this case, the strings R1 are arranged in a loose state. The tension applied to the strings R1 is increased to upwardly move the distal portions P1.

After upwardly moving the distal portions P1 of the leaves of the plant P with such moving units, the light source 24 is activated so that the rear sides of the leaves of the plant P may be illuminated with light in a further preferable manner. Any structure may be used as the moving unit as long as the structure upwardly moves the distal portions P1 of the leaves to change the positions of the rear sides of the leaves and illuminate the rear sides of the leaves with light.

Although not particularly mentioned in the above embodiments, as illustrated in FIGS. 17A and 17B, the insect pest disinfestation lighting device 10 (system) of each of the above embodiments and modifications are preferably used in a generally closed area such as a plant factory PF that cultivates the plants P. A generally closed area such as a plant factory PF may include a large number of spider mites that feed on the plants P, and the closed area may be free of predators of the spider mites. Thus, the arrangement of the insect pest disinfestation lighting device 10 in a generally closed area such as a plant factory PF allows for the disinfestations of spider mites.

In each of the above embodiments, the insect pest disinfestation lighting system includes a single insect pest disinfestation lighting device 10. Instead, an insect pest disinfestation lighting system may include a plurality of insect pest disinfestation lighting devices 10.

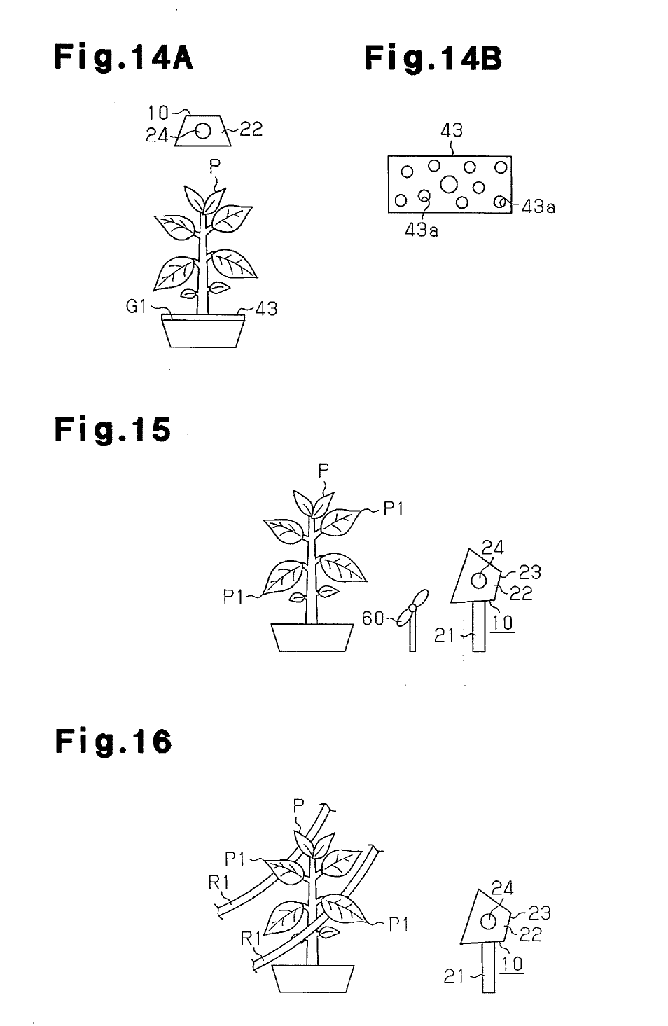

Although not particularly mentioned in the above embodiments, the light source 24 may illuminate the plant P with light during predetermined time periods between sunset and sunrise. For example, as illustrated in FIG. 18, the lighting device 10 may be electrically connected to a timer T, and the timer T may be used to determine whether or not to supply power from a power supply S to the lighting device 10. During the nighttime, there is no sunlight, and spider mites respond to even a small amount of light. This lengthens the moving distance of a spider mite, especially, an imago, and increases the time during which the spider mite is illuminated with the light from the light source 24. Thus, the emission of UV light from the light source 24 during the nighttime disinfests spider mites in a further preferable manner. Further, there may be no workers during the nighttime. This allows for reduction in the UV light emitted toward workers from the light source 24.

The present examples and embodiments are to be considered as illustrative and not restrictive, and the invention is not to be limited to the details given herein, but may be modified within the scope and equivalence of the appended claims.

1. An insect pest disinfestation lighting system comprising a light source that illuminates a rear side of a leaf of a plant with light having a wavelength from 260 to 305 nm in a range of 2 to 50 μW/cm².

2. The insect pest disinfestation lighting system according to claim 1, wherein the light source illuminates the rear side of the leaf of the plant with light emitted in a direction that is set in a range from a horizontal direction to a vertically upward direction.

3. The insect pest disinfestation lighting system according to claim 1, further comprising a reflector that reflects light from the light source, wherein the plant is illuminated with the light reflected by the reflector in addition to the light from the light source.

4. The insect pest disinfestation lighting system according to claim 1, further comprising a reflector that reflects light from the light source, wherein
the light source emits light in a direction that is set in a range from a horizontal direction to a vertically downward direction, and
the reflector reflects light from the light source to illuminate the rear side of the leaf of the plant with the reflected light.

5. The insect pest disinfestation lighting system according to claim 3, wherein the reflector is arranged between a distal portion of the leaf of the plant and a stem of the plant.

6. The insect pest disinfestation lighting system according to claim 5, wherein the reflector is supported to be movable.

7. The insect pest disinfestation lighting system according to claim 3, wherein the reflector includes a slit that passes light.

8. The insect pest disinfestation lighting system according to claim 3, wherein the reflector includes a through hole that passes light.

9. The insect pest disinfestation lighting system according to claim 3, wherein the reflector includes a reflection grain arranged on a culture medium of the plant.

10. The insect pest disinfestation lighting system according to claim 1, further comprising a moving unit that upwardly moves a distal portion of the leaf of the plant, wherein the light source illuminates the plant with light when the distal portion of the leaf of the plant is upwardly moved by the moving unit.

11. The insect pest disinfestation lighting system according to claim 1, wherein the light source illuminates the plant with light during a predetermined time period between sunset and sunrise.

12. The insect pest disinfestation lighting system according to claim 1, further comprising a predator releaser that releases a predator of an insect pest subject to disinfestation by the light from the light source.

13. The insect pest disinfestation lighting system according to claim 1, further comprising a pesticide sprayer that sprays a pesticide on the plant.
